(19) United States
(12) Patent Application Publication
(10) Pub. No.: US 2012/0009366 A1
(43) Pub. Date: Jan. 12, 2012

(54) Chemically Curing All-In-One Warm Edge Spacer And Seal

(76) Inventors: Thomas W. Galbraith, Freeland, MI (US); Loren Dale Lower, Sanford, MI (US); Patricia Ann Olney, Sanford, MI (US); Thomas Alexander Peitz, Mildland, MI (US); Angela L. Sherman, Midland, MI (US)

(21) Appl. No.: 13/259,431

(22) PCT Filed: Mar. 22, 2010
(86) PCT No.: PCT/US10/28133

§ 371 Date: Sep. 23, 2011

(30) Foreign Application Priority Data
Mar. 22, 2010 (US) PCT/US2010/028133

(51) Int. Cl. C08K 5/3475; E06B 3/24; E06B 3/66

(52) U.S. Cl. 428/34; 156/109; 524/91

(57) ABSTRACT

An “all-in-one” spacer and seal useful in insulating glass units is based on silane-functional, organic polymer which preferably has a low permeability (e.g., curable polyisobutylene or curable butyl rubber) technology. This chemically crosslinking (curing) flexible thermoset spacer and seal offers a solution to overcome the current shortfalls of commercially available thermoplastic spacer materials. When used as an edge-seal in an Insulating Glass unit, the cured product of the composition performs the functions of sealing, bonding, spacing, and desiccating.

### CROSS-REFERENCE TO RELATED APPLICATIONS

None.

### STATEMENT REGARDING FEDERALLY FUNDED RESEARCH AND DEVELOPMENT

None

### BACKGROUND OF THE INVENTION

1. Technical Field

An “all-in-one” spacer and seal useful in insulating glass units is based on silane-functional, organic polymer which preferably has a low permeability (e.g., curable polyisobutylene or curable butyl rubber) technology. This chemically crosslinking (curing) flexible thermoset spacer and seal offers a solution to overcome the current shortfalls of commercially available thermoplastic spacer materials. The thermoset material cures, develops adhesion, and offers the strength to support the glass panels of an insulating glass unit. The spacer and seal offers four functions of the edge-seal, namely sealing, bonding, spacing, and desiccating, thus an “all-in-one” solution.

2. Background

Insulating glass (IG) units are known in the art. In a typical IG unit, panes of glass are held parallel to one another a fixed distance apart by a spacer. A primary sealant is used as a barrier between the panes. The primary sealant may be used to prevent water vapour from migrating into the space between the panes (interpane space). The primary sealant may also be used to prevent inert gas, such as argon, from migrating out of the interpane space. A secondary sealant is used to adhere the panes to each other and the spacer. Desiccants may be added to the spacer to remove moisture from the interpane space. The spacer may be formed from metal (e.g., aluminum or stainless steel), plastic, plastic coated metal, foam (e.g., ethylene propylene diene rubber (EPDM) or silicone), or other suitable materials.

### Problems to be Solved

A more efficient method for producing IG units is desired. A single sealant composition that performs more than one of the functions of the primary sealant, secondary sealant, spacer, and desiccant namely sealing, bonding, spacing, and desiccation, is desired. Preferably, a single sealant composition that performs all of these functions, thus an “all-in-one” solution, is desired. It is desirable for the sealant composition to be manufacturable with conventional continuous compounding equipment, such a twin screw extruder.

### BRIEF SUMMARY OF THE INVENTION

A composition is disclosed which is useful as an “all-in-one” sealant in IG applications. The composition comprises: (A) a moisture-curable, silane-functional, low permeability, organic polymer; (B) a condensation catalyst; and (C) a silanol functional silicone resin.

### BRIEF DESCRIPTION OF THE DRAWINGS

FIG. 1 is a partial cross section of an IG unit.

FIG. 2 is a partial cross section of an IG unit.

### DETAILED DESCRIPTION OF THE INVENTION

A composition useful in IG applications as an “all-in-one” sealant is disclosed. The composition may be a one-part or multiple-part composition. The composition comprises: (A) 10 to 65 weight % of a moisture-curable, silane-functional, low permeability, organic polymer; (B) 0.05 to 3 weight % of a condensation catalyst; (C) 1 to 25 weight % of a silanol functional silicone resin; (D) 0 to 25 weight % of a drying agent; (E) 0 to 30 weight % of a filler other than ingredient (D); (F) 0 to 30 weight % of a non-reactive, elastomeric, organic polymer; (G) 0 to 5 weight % of a crosslinker; (H) 0 to 5 weight % of a chemical drying agent other than ingredient (G); (I) 0 to 5 weight % of an adhesion promoter other than ingredients (G) and (H); (J) 0 to 20 weight % of a microcrystalline wax, which is a solid at 25° C. and has a melting point selected such that the wax melts at the low end of the desired application temperature range; (K) 0 to 3 weight % of an anti-aging additive; and (L) 0 to 20 weight % of a tackifying agent. For the avoidance of doubt whilst the cumulative amounts of the constituents present or optionally present may add up to a value greater than or less than 100%, it is to be understood that the total weight % of any composition in accordance with the present invention is equal to 100%.

### Ingredient (A) Moisture-Curable, Silane-Functional, Low Permeability, Organic Polymer

Ingredient (A) is a moisture-curable, silane-functional, organic polymer. It is preferred that ingredient (A) is of low permeability. For purposes of this application, ‘low permeability’ means that when the composition is used in an insulating glass unit as a single or dual edge seal, ingredient (A) imparts a property to the cured product of the composition (sealant) such that the sealant is able to withstand environmental conditions that include exposure to water and/or water vapour during the useful life of the I unit in which the composition is used and the unit meets relevant industry performance standards, such as EN 1279-2, EN 1279-3, or ASTM E2190-08. Ingredient (A) may be elastomeric, i.e., have a glass transition temperature (Tg) less than 0° C. When ingredient (A) is elastomeric, ingredient (A) may be distinguished from semi-crystalline and amorphous polyolefins (e.g., alpha-olefins), commonly referred to as thermoplastic polymers. The sealant prepared by curing the composition may be elastomeric in that when ingredient (A) is elastomeric, the sealant may have a rubbery consistency imparted to the composition by ingredient (A).

Ingredient (A) may comprise a silylated poly-alpha-olefin, a silylated copolymer of an iso-mono-olefin and a vinyl aromatic monomer, a silylated copolymer of a diene and a vinyl aromatic monomer, a silylated copolymer of an olefin and a diene (e.g., a silylated butyl rubber prepared from polyisobutylene and isoprene, which may optionally be halogenated), or a combination thereof (silylated copolymers), a silylated homopolymer of the iso-mono-olefin, a silylated homopolymer of the vinyl aromatic monomer, a silylated homopolymer of the diene (e.g., silylated polybutadiene or silylated hydrogenated polybutadiene), or a combination thereof (silylated homopolymers) or a combination silylated copolymers and silylated homopolymers. For purposes of this application, silylated copolymers and silylated homopolymers are referred to collectively as ‘silylated polymers’. The silylated polymer may optionally contain one or more halogen groups, particularly bromine groups.

Ingredient (A) may comprise a silane-functional group of formula:

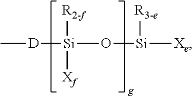

where D represents a divalent organic group, each X independently represents a hydrolyzable group, each R independently represents a monovalent hydrocarbon group, subscript e represents 0, 1, 2, or 3, subscript f represents 0, 1, or 2, and subscript g has a value ranging from 0 to 18, with the proviso that the sum of e+f is at least 1, and at least one X is present in the formula.

Alternatively, D may be a divalent hydrocarbon group such as ethylene, propylene, butylene, and hexylene. Alternatively, each X may be selected from the group consisting of an alkoxy group; an alkenyloxy group; an amido group, such as an acetamido, a methylacetamido group, or benzamido group; an acyloxy group such as acetoxy; an amino group; an aminoxy group; a hydroxyl group; a mercapto group; an oximo group, and a ketoximo group. Alternatively, each R may be independently selected from alkyl groups of 1 to 20 carbon atoms, aryl groups of 6 to 20 carbon atoms, and aralkyl groups of 7 to 20 carbon atoms. Alternatively, subscript g is 0.

Examples of suitable mono-iso-olefins include but are not limited to isoalkylenes such as isobutylene, isopentylene, isohexylene, and isoheptylene;

alternatively isobutylene. Examples of suitable vinyl aromatic monomers include but are not limited to alkylstyrenes such as alpha-methylstyrene, t-butylstyrene, and para-methylstyrene; alternatively para-methylstyrene. Examples of suitable alkyl groups include methyl, ethyl, n-propyl, isopropyl, n-butyl, isobutyl, and t-butyl; alternatively methyl. Examples of suitable alkenyl groups include, vinyl, allyl, propenyl, butenyl, and hexenyl; alternatively vinyl. Ingredient (A) may have average molecular weight (Mn) ranging from 20,000 to 500,000, alternatively 50,000-200,000, alternatively 20,000 to 100,000, alternatively 25,000 to 50,000, and alternatively 28,000 to 35,000. All values of Mn above are measured by Triple Detection Size Exclusion Chromatography and calculated on the basis of polystyrene molecular weight standards.

Ingredient (A) may contain silane-functional groups described by the formula above in an amount ranging from 0.2 mol % to 10 mol %, alternatively 0.5 mol % to 5 mol %, and alternatively 0.5 mol % to 2.0 mol %, alternatively 0.5 mol % to 1.5 mol %, and alternatively 0.6 mol % to 1.2 mol %.

Suitable examples of silylated poly-alpha-olefins are known in the art and are commercially available. Examples include the condensation reaction curable silylated polymers marketed as VESTOPLAST®, which are commercially available from Degussa AG Coatings & Colorants of Marl, Germany.

Suitable examples of silylated copolymers and methods for their preparation are known in the art and are exemplified by the silylated copolymers disclosed in EP 0 320 259 B1 (Dow Corning); DE 19,821,356 A1 (Metallgesellschaft); and U.S. Pat. Nos. 4,900,772 (Kaneka); 4,904,732 (Kaneka); 5,120,379 (Kaneka); 5,262,502 (Kaneka); 5,290,873 (Kaneka); 5,580,925 (Kaneka), 4,808,664 (Dow Corning), 6,380,316 (Dow Corning/ExxonMobil); and 6,177,519 (Dow Corning/ExxonMobil). U.S. Pat. Nos. 6,380,316 and 6,177,519 are hereby incorporated by reference. Briefly stated, the method for preparing the silylated copolymers of U.S. Pat. No. 6,177,519 involves contacting i) an olefin copolymer having at least 50 mole % of an iso-mono-olefin having 4 to 7 carbon atoms and a vinyl aromatic monomer; ii) a silane having at least two hydrolyzable organic groups and at least one olefinically unsaturated hydrocarbon or hydrocarbonoxy group; and iii) a free radical generating agent.

Alternatively, silylated copolymers may be prepared by a method comprising conversion of commercially available hydroxylated polybutadiene (such as those commercially available from Sartomer under tradename Poly BD) by known methods (e.g., reaction with isocyanate functional alkoxysilane, reaction with allylchloride in presence of Na followed by hydrosilylation).

The amount of ingredient (A) may range from 10 to 65 weight %, alternatively 10 to 35 weight %, and alternatively 15 to 35 weight %, based on the weight of the composition. All amounts, ratios, and percentages in this application are by weight, unless otherwise indicated, Ingredient (A) may be one moisture-curable, silane-functional, low permeability, organic polymer. Alternatively, ingredient (A) may comprise two or more moisture-curable, silane-functional, low permeability, organic polymers that differ in at least one of the following properties: structure, viscosity, average molecular weight, polymer units, and sequence. For purposes of this application, the articles ‘a’, ‘an’, and ‘the’ may each refer to one or more.

### Ingredient (B) Condensation Catalyst

Ingredient (B) is a condensation catalyst. Suitable condensation catalysts include tin (IV) compounds, tin (II) compounds, and titanates. Examples of tin (IV) compounds include dibutyl tin dilaurate (DBTDL), dimethyl tin dilaurate, di-(n-butyl)tin bis-ketonate, dibutyl tin diacetate, dibutyl tin maleate, dibutyl tin di acetylacetonate, dibutyl tin dimethoxide carbomethoxyphenyl tin tris-uberate, isobutyl tin triceroate, dimethyl tin dibutyrate, dimethyl tin di-neodeconoate (DMDTN), triethyl tin tartrate, dibutyl tin dibenzoate, butyltintri-2-ethylhexoate, a dioctyl tin diacetate, tin octylate, tin oleate, tin butyrate, tin naphthenate, dimethyl tin dichloride, and a combination thereof. Tin (IV) compounds are known in the art and are commercially available, such as Metatin® 740 and Fascat(®) 4202.

Examples of tin (II) compounds include tin (II) salts of organic carboxylic acids such as tin (II) diacetate, tin (II) dioctanoate, tin (II) diethylhexanoate, tin (II) dilaurate, stannous salts of carboxylic acids such as stannous octoate, stannous oleate, stannous acetate, stannous laurate, and a combination thereof.

Examples of organofunctional titanates include 1,3-propanedioxytitanium bis(ethylacetoacetate); 1,3 -propanedioxytitanium bis(acetylacetonate); diisopropoxytitanium bis(acetylacetonate); 2,3-di-isopropoxy-bis(ethylacetate)titanium; titanium naphthenate; tetrapropyltitanate; tetrabutyltitanate; tetraethylhexyltitanate; tetraphenyltitanate; tetraoctadecyltitanate; tetrabutoxytitanium; tetraisopropoxytitanium; ethyltriethanolaminetitanate; a betadicarbonyltitanium compound such as bis(acetylacetonyl)diisopropyltitanate; or a combination thereof. Siloxytitanates are exemplified by tetrakis(trimethylsiloxy)titanium, bis(trimethylsiloxy)bis(isopropoxy)titanium, or a combination thereof.

The amount of ingredient (B) is sufficient to cure the composition. The amount of ingredient (B) may range from 0.03 to 3 weight %, alternatively 0.1 to 3 weight %, and alternatively 0.2 to 2 weight %, based on the weight of the composition. Ingredient (B) may be one condensation catalyst. Alternatively, ingredient (B) may comprise two or more different condensation catalysts.

### Ingredient (C) Silanol Functional Silicone Resin

Ingredient (C) is a silanol functional silicone resin. Ingredient (C) is selected such that ingredient (C) contains an amount of silanol groups sufficient to cure the composition and such that the sufficient amount of silanol groups are reactive enough to cure the composition when exposed for an application time at a temperature in the application temperature range, for example, by the method of reference example 2 herein. However, ingredient (C) has a sufficiently low volatility and is sufficiently stable to prevent too much silanol from being released during processing. For example, ingredient (C) binds the silanol groups sufficiently during compounding of the composition such that sufficient silanol groups are available for curing the composition during or after the application process in which the composition is used. For example, when the composition will be used in an IG application, the application temperature range may be the temperature range at which the composition will be applied or interposed between glass panes. The application temperature range will depend on various factors including the IG unit fabricator's particular fabrication process.

Silanol functional silicone resins are known in the art and commercially available. Silanol functional silicone resins can comprise combinations of M, D, T, and Q units, such as DT, MDT, DTQ, MQ, MDQ, MDTQ, or MTQ resins; alternatively T (silsesquioxane) resins or DT resins. For purposes of this application,

“D unit” means a unit of the formula R⁷₂SiO_{2/2}, “M unit” means a unit of the formula R⁷₃SiO_{1/2}, “Q unit” means a unit of the formula SiO_{4/2}, and “T unit” means a unit of the formula R⁷SiO_{3/2}; where each R⁷ is independently an organic group or a silanol group

DT resins are exemplified by resins comprising the formula:
(R⁸R⁹SiO_{2/2})ₕ(R¹⁰SiO_{3/2})ᵢ.

Each instance of R⁸, R⁹ and R¹⁰ may be the same or different. R⁸, R⁹ and R¹⁰ may be different within each unit. Each R⁸, R⁹ and R¹⁰ independently represent a hydroxyl group or an organic group, such as a hydrocarbon group or alkoxy group. Hydrocarbon groups can be saturated or unsaturated. Hydrocarbon groups can be branched, unbranched, cyclic, or combinations thereof. Hydrocarbon groups can have 1 to 40 carbon atoms, alternatively 1 to 30 carbon atoms, alternatively 1 to 20 carbon atoms, alternatively 1 to 10 carbon atoms, and alternatively 1 to 6 carbon atoms. The hydrocarbon groups may include alkyl groups such as methyl, ethyl, n-propyl, isopropyl, n-butyl, and t-butyl; alternatively methyl or ethyl; and alternatively methyl. The hydrocarbon groups may include aromatic groups such as phenyl, tolyl, xylyl, benzyl, and phenylethyl; and alternatively phenyl. Unsaturated hydrocarbon groups include alkenyl such as vinyl, allyl, butenyl, and hexenyl.

In the formula above, h may range from 1 to 200, alternatively 1 to 100, alternatively 1 to 50, alternatively 1 to 37, and alternatively 1 to 25. In the formula above, i may range from 1 to 100, alternatively 1 to 75, alternatively 1 to 50, alternatively 1 to 37, and alternatively 1 to 25.

Alternatively, the DT resin may have the formula: (R⁸₂SiO_{2/2})ₕ(R⁹₂SiO_{2/2})ᵢ (R⁸SiO_{3/2})ₕ(R⁹SiO_{3/2})ᵢ, where R⁸, R⁹, h, and i are as described above. Alternatively, in this formula, each R⁸ may be an alkyl group and each R⁹ may be an aromatic group.

MQ resins are exemplified by resins of the formula: (R⁸R⁹R³SiO_{1/2})ⱼ(SiO_{4/2})ₖ, where R⁸, R⁹ and R¹⁰ are as described above, j is 1 to 100, and k is 1 to 100, and the average ratio of j to k is 0.65 to 1.9.

In the formulae above, the silanol content, e.g., amount of R⁸, R⁹ and/or R¹⁰ groups that are OH groups (silanol), depends on various factors including the molecular weight, structure, and location of the OH groups, however, silanol content may range from 3% to 10%, alternatively 5% to 7%, based on the weight of the silanol functional silicone resin.

When the composition is prepared with continuous process equipment (e.g., twin-screw extruder), the ingredients may be compounded at a temperature ranging from 20° C. to 30° C. above the application temperature range for a short amount of time. Therefore, ingredient (C) is selected to ensure that not all of the silanol content is removed during compounding, however the silanol groups of ingredient (C) cure the composition when exposed to the application temperature range for a sufficient period of time.

The silanol functional silicone resin selected will depend on various factors including the other ingredients selected for the composition, including catalyst type and amount and compatibility with the polymer ingredient (A); and the process conditions during compounding, packaging, and application. In a twin-screw compounder residence time may be less than a few minutes, typically 1 to 5 minutes, alternatively 1 to 2 minutes. The ingredients are heated rapidly because the surface/volume ratio in the barrels and along the screw is high and heat is induced by shearing the ingredients. How much silanol content is removed from the composition depends on the binding capabilities of the silanol functional silicone resin, the temperature, the exposure time (duration), and the level of vacuum used to strip the material passing through the compounder. Even with compounding temperatures of up to 200° C., alternatively 130° C. to 200° C., and full operational vacuum stripping, there remains silanol content sufficient to cure the composition, after ca. 3 weeks ambient storage, when exposed afterwards at 90° C. for ca. 30 minutes.

The amount of ingredient (C) in the composition depends on various factors including the selection of ingredients (A) and (B), whether any optional ingredients are present, and the degree of polymerization and amount of reactive silanol groups in ingredient (C), and the reactive hydrolyzable group content of ingredient (A). For purposes of this application, ‘reactive’ means the amount of OH or other hydrolyzable group that is sufficiently sterically unhindered to react under the curing conditions of the composition. The silanol content of ingredient (C) may be at least 70 mol % of the hydrolyzable group content of ingredient (A), alternatively at least 90 mol %, and alternatively 70 mol % to 100 mol %. Alternatively, the silanol functional silicone resin may be present in an amount sufficient to provide a silanol content ranging from 1 mole to 3 mole of silanol, per 1 mole of hydrolyzable groups bonded to ingredient (A).

Without wishing to be bound by theory, it is thought that the present invention provides a benefit over previous compositions that contain liquid water, hydrated metal salts such as those disclosed by U.S. Pat. No. 6,025,445, and hydrated fillers. It is thought that adding liquid water to the composition may form steam during the compounding process to make the composition, during the application process of the composition to a substrate, or both. It is thought that hydrated metal salts may have a negative effect on the adhesion of composition, especially when the adhesion needs to withstand environmental conditions that include water or water vapour. It is thought that the hydrated fillers may not be able to contain a sufficient amount of water to cure the composition effectively when the composition is made on a continuous compounder at low pressure and high temperatures (e.g., of 130° C. or higher). The silanol functional silicone resin may provide the benefit of a consistent amount of silanol groups after compounding the ingredients to make the composition in commercial scale equipment.

### Ingredient (D) Drying Agent

Ingredient (D) is a drying agent that may optionally be added to the composition. The drying agent binds water from various sources. In IG applications, the drying agent may bind water that an IG unit contains between panes upon its manufacture and/or that diffuses into the interpane space during service life of the IG unit. The drying agent may bind by-products of the curing reaction such as water and alcohols. The drying agent binds the water and by-products by physical means. For example, the drying agent may bind the water and by-products by physically adsorbing or absorbing them. Ingredient (D) may be added to the composition to perform the desiccating function of an edge-seal in an IG unit and to reduce or eliminate chemical fogging of the IG unit that may be caused by by-products of the curing reaction.

Examples of suitable adsorbents for ingredient (D) may be inorganic particulates. The adsorbent may have a particle size of 10 micrometers or less, alternatively 5 micrometers or less. The adsorbent may have average pore size sufficient to adsorb water and alcohols, for example 10 Å (Angstroms) or less, alternatively 5 Å or less, and alternatively 3 Å or less. Examples of adsorbents include zeolites such as chabasite, mordenite, and analcite; molecular sieves such as alkali metal alumino silicates, silica gel, silica-magnesia gel, activated carbon, activated alumina, calcium oxide, and combinations thereof. One skilled in the art would be able to select suitable drying agents for ingredient (D) without undue experimentation. One skilled in the art would recognize that certain drying agents such as silica gel will bind water, while others such as molecular sieves may bind water, alcohols, or both.

Examples of commercially available drying agents include dry molecular sieves, such as 3 < (Angstrom) molecular sieves, which are commercially available from Grace Davidson under the trademark SYLOSIV® and from Zeochem of Louisville, Ky., U.S.A. under the trade name PURMOL, and 4 Å molecular sieves such as Doucil® zeolite 4A available from Ineos Silicas of Warrington, England. Other useful molecular sieves include MOLSIV® ADSORBENT TYPE 13X, 3A, 4A, and 5A, all of which are commercially available from UOP of Illinois,

U.S.A.; SILIPORITE® NK 30AP and 65×P from Atofina of Philadelphia, Pa., U.S.A.; and molecular sieves available from W.R. Grace of Maryland, U.S.A. The amount of ingredient (D) in the composition may range from 0 to 25%, alternatively 15% to 25%, based on the weight of the composition.

### Ingredient (E) Filler

The composition may optionally further comprise additional ingredient (E). Ingredient (E) is a filler other than ingredient (D). Ingredient (E) generally does not significantly impact the amount of water present during and after curing the composition. Ingredient (E) may comprise a reinforcing filler, an extending filler, a thixotropic filler, a pigment, or a combination thereof. One skilled in the art would be able to select suitable additional fillers without undue experimentation. Examples of suitable additional fillers include, but are not limited to, precipitated calcium carbonate, ground calcium carbonate, fumed silica, precipitated silica, talc, titanium dioxide, plastic powders, glass or plastic (such as Saran™) microspheres, high aspect ratio fillers such as mica or exfoliated mica, and combinations thereof. The filler may optionally be treated with a treating agent, such as a fatty acid (e.g., stearic acid).

Suitable fillers are known in the art and are commercially available. Precipitated calcium carbonate is available from Solvay under the trademark WINNOFIL® SPM. Ground calcium carbonate is available from QCI Britannic of Miami, Fla., U.S.A. under the trademark Imerys Gammasperse. Carbon black, such as 1011, is commercially available from Williams. Silica is commercially available from Cabot Corporation.

The amount of ingredient (E) in the composition depends on various factors including the type, particle size, and surface treatment of the filler selected. However, the amount of ingredient (E) may range from 0 to 30 weight %, alternatively 5 to 30 weight %, based on the weight of the composition. Ingredient (E) may be one filler. Alternatively, ingredient (E) may comprise two or more fillers that differ in at least one of the following properties: composition, particle size, and surface treatment.

### Ingredient (F) Non-reactive Binder

Ingredient (F) is a non-reactive, elastomeric, organic polymer, i.e., an elastomeric organic polymer that does not react with ingredient (A). Ingredient (F) is compatible with ingredient (A), i.e., ingredient (F) does not form a two-phase system with ingredient (A). Ingredient (F) may have sufficiently low gas and moisture permeability, for example, if the composition will be used in an IG application. Ingredient (F) may have Mn ranging from 30,000 to 75,000. Alternatively, ingredient (F) may be a blend of a higher molecular weight, non-reactive, elastomeric, organic polymer with a lower molecular weight, non-reactive, elastomeric, organic polymer. In this case, the higher molecular weight polymer may have Mn ranging from 100,000 to 600,000 and the lower molecular weight polymer may have Mn ranging from 900 to 10,000, alternatively 900 to 3,000. The value for the lower end of the range for Mn may be selected such that ingredient (F) has compatibility with ingredient (A) and the other ingredients of the composition to minimize chemical fogging in an IG unit in which the composition will be used. All values of Mn above are measured by Triple Detection Size Exclusion Chromatography and calculated on the basis of polystyrene molecular weight standards.

Ingredient (F) may comprise a polyisobutylene. Polyisobutylenes are known in the art and are commercially available. Examples suitable for use as ingredient (F) include polyisobutylenes marketed under the trademark OPPANOL® by BASF Corporation of Germany. Such polyisobutylenes are summarized in the table below (details having been taken from the relevant datasheets current at the time of filing the priority application (U.S. 61/162378) for this application.

| | | | | | Viscosity |
|---|---|---|---|---|---|
| OPPANOL ® | Mw | Mw/Mn | Mn | Mv | (@150 C.) |
| B10 | 36,000 | 3 | 12,000 | 40,000 | 40,000 |
| B11 | 46,000 | 3.2 | 14,375 | 49,000 | 100,000 |
| B12 | 51,000 | 3.2 | 15,938 | 55,000 | 150,000 |
| B13 | 60,000 | 3.2 | 18,750 | 65,000 | 250,000 |
| B14 | 65,000 | 3.3 | 19,697 | 73,000 | 450,000 |
| B15 | 75,000 | 3.4 | 22,059 | 85,000 | 750,000 |
| B30 | | | 73,000 | 200,000 | |
| B50 | | | 120,000 | 400,000 | |
| B80 | | | 200,000 | 800,000 | |
| B100 | | | 250,000 | 1,100,000 | |
| B150 | | | 425,000 | 2,600,000 | |
| B200 | | | 600,000 | 4,000,000 | |

Other polyisobutylenes include different Parleam grades such as highest molecular weight hydrogenated polyisobutene PARLEAM® SV (POLYSYNLANE SV) from NOF CORPORATION Functional Chemicals & Polymers Div., Yebisu Garden Place Tower, 20-3 Ebisu 4-chome, Shibuya-ku, Tokyo 150-6019, Japan (Kinematic Viscosity (98.9° C.). 4700). Other polyisobutylenes are commercially available from ExxonMobil Chemical Co. of Baytown, Tex., U.S.A. and include polyisobutylenes marketed under the trademark VISTANEX®, such as MML-80, MML-100, MML-120, and MML-140. VISTANEX® polyisobutylenes are paraffinic hydrocarbon polymers, composed of long, straight-chain macromolecules containing only chain-end olefinic bonds. VISTANEX® MM polyisobutylenes have viscosity average molecular weight ranging from 70,000 to 90,000. Lower molecular weight polyisobutylenes include VISTANEX® LM, such as LM-MS (viscosity average molecular weight ranging from 8,700 to 10,000 also made by ExxonMobil Chemical Co.) and VISTANEX LM-MH (viscosity average molecular weight of 10,000 to 11,700) as well as Soltex PB-24 (Mn 950) and Indopol® H-100 (Mn 910) and Indopol® H-1200 (Mn 2100) from Amoco. Other polyisobutylenes are marketed under the trademarks NAPVIS® and HYVIS® by BP Chemicals of London, England. These polyisobutylenes include NAPVIS® 200, D10, and DE3; and HYVIS200. The NAPVIS® polyisobutylenes may have Mn ranging from 900 to 1300.

Alternatively, ingredient (F) may comprise butyl rubber. Alternatively, ingredient (F) may comprise a styrene-ethylene/butylene-styrene (SEBS) block copolymer, a styrene-ethylene/propylene-styrene (SEPS) block copolymer, or a combination thereof. SEBS and SEPS block copolymers are known in the art and are commercially available as Kraton® G polymers from Kraton Polymers U.S. LLC of Houston, Tex., U.S.A., and as Septon polymers from Kuraray America, Inc., New York, N.Y., U.S.A. Alternatively, ingredient (F) may comprise a polyolefin plastomer. Polyolefin plastomers are known in the art and are commercially available as AFFINITY® GA 1900 and AFFINITY® GA 1950 from Dow Chemical Company, Elastomers & Specialty Products Division, Midland, Mich., U.S.A.

The amount of ingredient (F) range from 0 to 50 weight %, alternatively 10 to 40 weight %, and alternatively 5 to 35 weight %, based on the weight of the composition. Ingredient (F) may be one non-reactive, elastomeric, organic polymer. Alternatively, ingredient (F) may comprise two or more non-reactive, elastomeric, organic polymers that differ in at least one of the following properties: structure, viscosity, average molecular weight, polymer units, and sequence.

### Ingredient (G) Crosslinker

Ingredient (G) is a crosslinker. Ingredient (G) may be a silane, an oligomeric reaction product of the silane, or a combination thereof. Alkoxysilane crosslinkers may have the general formula R¹ₐSiR²₍₄₋ₐ₎, where each R¹ is independently a monovalent organic group such as an alkyl group, alkenyl group, or aryl group; each R² is a hydrolyzable group; and a is 1, 2, or 3. Oligomeric crosslinkers may have the general formula R¹Si(OSi(R²)₃)₃, where R¹ and R² are as described above.

In the formulae above, suitable monovalent organic groups for R¹ include, but are not limited to, monovalent substituted and unsubstituted hydrocarbon groups. Examples of monovalent unsubstituted hydrocarbon groups for R¹ include, but are not limited to, alkyl such as methyl, ethyl, propyl, pentyl, octyl, undecyl, and octadecyl; cycloalkyl such as cyclohexyl; alkenyl such as vinyl, allyl, and propenyl; aryl such as phenyl, tolyl, xylyl, benzyl, and 2-phenylethyl. Examples of monovalent substituted hydrocarbon groups for R¹ include, but are not limited to, monovalent halogenated hydrocarbon groups such as chlorinated alkyl groups such as chloromethyl and chloropropyl groups; fluorinated alkyl groups such as fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocycliopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl. Examples of monovalent substituted hydrocarbon groups for R¹ include, but are not limited to, hydrocarbon groups substituted with oxygen atoms such as glycidoxyalkyl, and hydrocarbon groups substituted with nitrogen atoms such as aminoalkyl and cyano-functional groups such as cyanoethyl and cyanopropyl. Alternatively, each le may be an alkyl group, alkenyl group, or aryl group.

Each R² may be independently selected from an alkoxy group; an alkenyloxy group; an amido group, such as an acetamido, a methylacetamido group, or benzamido group; an acyloxy group such as acetoxy; an amino group; an aminoxy group; a hydroxyl group; a mercapto group; an oximo group, and a ketoximo group. Alternatively, each R² may be an alkoxy group. Suitable alkoxy groups for R² include, but are not limited to, methoxy, ethoxy, propoxy, and butoxy.

Ingredient (G) may comprise an alkoxysilane exemplified by a dialkoxysilane, such as a dialkyldialkoxysilane or a trialkoxysilane, such as an alkyltrialkoxysilane or alkenyltrialkoxysilane, or partial or full hydrolysis products thereof, or another combination thereof. Examples of suitable trialkoxysilanes include methyltrimethoxysilane, methyltriethoxysilane, ethyltrimethoxysilane, ethyltriethoxysilane, phenyltriethoxysilane, phenyltrimethoxysilane, vinyltrimethoxysilane, vinyltriethoxysilane, and a combination thereof. Examples of alkoxysilane crosslinkers are disclosed in U.S. Pat,. Nos. 4,962,076; 5,051,455; and 5,053,442.

Alternatively, ingredient (G) may comprise a dialkoxysilane selected from chloromethylmethyldimethoxysilane, chloromethylmethyldiethoxysilane, dimethyldimethoxysilane, methyl-n-propyldimethoxysilane, (2,2-dichlorocyclopropyl)-methyldimethoxysilane, (2,2-difluorocyclopropyl)-methyldiethoxysilane, (2,2-dichlorocyclopropyl)-methyldiethoxysilane, fluoromethyl-methyldiethoxysilane, fluoromethyl-methyldimethoxysilane, or a combination thereof.

Alternatively, ingredient (G) may comprise a trialkoxysilane selected from methyltrimethoxysilane, ethyltrimethoxysilane, propyltrimethoxysilane, isobutyltrimethoxysilane, cyclopentyltrimethoxysilane, hexyltrimethoxysilane, phenyltrimethoxysilane, 2-ethyl-hexyltrimethoxysilane, 2,3-dimethylcyclohexyltrimethoxislane, glycidoxypropyltrimethoxysilane, aminoethylaminopropyltrimethoxysilane, (ethylenediaminepropyl)trimethoxysilane, 3-methacryloxypropyltrimethoxysilane, chloromethyltrimethoxysilane, 3-chloropropyltrimethoxysilane, trichlorophenyltrimethoxysilane, 3,3,3-trifluoropropyl trimethoxysilane, 4,4,4,3,3-pentafluorobutyltrimethoxysilane, 2,2-difluorocyclopropyltriethoxysilane, methyltriethoxysilane, cyclohexyltriethoxysilane, chloromethyltriethoxysilane, tetrachlorophenyltriethoxysilane, fluoromethyltriethoxysilane, methyltriisopropoxysilane, methyl-tris(methoxyethoxy)silane, n-propyl-tris(3-methoxyethoxy)silane, phenyltris-(methoxyethoxy)silane, vinyltrimethoxysilane, vinyltriethoxysilane, or a combination thereof.

Alternatively, ingredient (G) may comprise a tetraalkoxysilane selected from tetraethoxysilane, tetrapropoxysilane, tetrabutoxysilane, or a combination thereof.

The amount of ingredient (G) depends on the specific crosslinker selected. However, the amount of ingredient (G) may range from 0 to 5 weight %, alternatively 0.1 to 5 weight %, based on the weight of the composition. Ingredient (G) may be one crosslinker. Alternatively, ingredient (G) may comprise two or more different crosslinkers.

Ingredient (G) may comprise an acyloxysilane, such as an acetoxysilane. Acetoxysilanes include a tetraacetoxysilane, an organotriacetoxysilane, a diorganodiacetoxysilane, or a combination thereof. The acetoxysilane may contain alkyl groups such as methyl, ethyl, propyl, isopropyl, butyl, and tertiary butyl; alkenyl groups such as vinyl, allyl, or hexenyl; aryl groups such as phenyl, tolyl, or xylyl; aralkyl groups such as benzyl or 2-phenylethyl; and fluorinated alkyl groups such as 3,3,3-trifluoropropyl. Alternatively, ingredient (G) may comprise organotriacetoxysilanes, for example mixtures containing methyltriacetoxysilane and ethyltriacetoxysilane.

Alternatively, ingredient (G) may comprise a ketoximosilane. Examples of ketoximosilanes for ingredient (G) include, but are not limited to, tetra(methylethylketoximo)silane, methyl-tris-(methylethylketoximo)silane, vinyl-tris-(methylethylketoximo)silane, and combinations thereof.

Alternatively, ingredient (G) may comprise a disilane of formula R⁴₃Si-D-SiR⁴₃, where R⁴ and D are as described herein. Examples of such disilanes include bis(triethoxysilyl)hexane), 1,4-bis[trimethoxysilyl(ethyl)]benzene, and bis[3-(triethoxysilyl)propyl] tetrasulfide, as described in, e.g., U.S. Pat. No. 6,130,306.

### Ingredient (H) Chemical Drying Agent

Alternatively, an amount of a crosslinker added to the composition in addition to ingredient (G) may function as a chemical drying agent. Without wishing to be bound by theory, it is thought that the chemical drying agent may be added to the dry part of a multiple part composition to keep the composition free from water and to assist in binding water coming from ingredient (D) after the parts of the composition are mixed together. For example, alkoxysilanes suitable as drying agents include vinyltrimethoxysilane, vinyltriethoxysilane, and combinations thereof.

The amount of ingredient (H) depends on the specific drying agent selected. However, the amount of ingredient (H) may range from 0 to 5 weight %, alternatively 0.1 to 0.5 weight %, Ingredient (H) may be one chemical drying agent. Alternatively, ingredient (H) may comprise two or more different chemical drying agents.

### Ingredient (I) Adhesion Promoter

Ingredient (I) is an adhesion promoter. Ingredient (I) may be an organofunctional silane other than ingredient (G). The organofunctional silane may have the general formula R³_{b}SiR⁴_{(4-b)}, where each R³ is independently a monovalent organic group; each R⁴ is an alkoxy group; and b is 0, 1, 2, or 3, alternatively b may be 0 or 1.

Alternatively, the adhesion promoter may comprise an organofunctional silane having the formula R⁵_{c}R⁶_{d}Si(OR⁵)_{4-(c+d)} where each R⁵ is independently a substituted or unsubstituted, monovalent hydrocarbon group having at least 3 carbon atoms and each R⁶ contains at least one SiC bonded group having an adhesion-promoting group, such as amino, epoxy, mercapto or acrylate groups, c has the value of 0 to 2 and d is either 1 or 2 and the sum of c+d is not greater than 3. The adhesion promoter can also be a partial condensate of the above silane.

Examples of ingredient (I) include a trialkoxysilane such as gamma-aminopropyltriethoxysilane, (ethylenediaminepropyl)trimethoxysilane, vinyltriethoxysilane, (methacryloxypropyl)trimethoxysilane, vinyltrimethoxysilane; and a tetraalkoxysilane such as tetraethoxysilane; and combinations thereof.

Alternatively, ingredient (I) may comprise a dialkoxysilane such as vinyl,methyl,dimethoxysilane; vinyl,methyl,diethoxysilane; vinyl,ethyl,dimethoxysilane; vinyl,ethyl,diethoxysilane; or a combination thereof.

Alternatively, ingredient (I) may comprise a trialkoxysilane selected from glycidoxypropyltrimethoxysilane, aminoethylaminopropyltrimethoxysilane, (ethylenediaminepropyptrimethoxysilane, 3-methacryloxypropyltrimethoxysilane, vinyltrimethoxysilane, vinyltriethoxysilane, or a combination thereof.

Alternatively, ingredient (I) may comprise a tetraalkoxysilane selected from tetraethoxysilane, tetrapropoxysilane, tetrabutoxysilane, or a combination thereof.

Alternatively, ingredient (I) may comprise a reaction product of an epoxy-functional silane and an amino-functional silane, described above, and as exemplified by those disclosed in U.S. Pat. Nos. 4,602,078 and 5,405,889. Alternatively, ingredient (I) may comprise a silatrane derivative derived from an epoxy-functional silane and an amine compound as exemplified by those in U.S. Pat. No. 5,936,110.

Alternatively, ingredient (I) may comprise a disilane of formula R⁴₃Si-D-SiR⁴₃, where R⁴ and D are as described above. Examples of such disilanes include bis(triethoxysilyl)hexane), 1,4-bis[trimethoxysilyl(ethyl)]benzene, and bis[3-(triethoxysilyl)propyl] tetrasulfide, as described in, e.g., U.S. Pat. No. 6,130,306.

The amount of ingredient (I) depends on the specific adhesion promoter selected. One skilled in the art would recognize that certain examples for ingredients (G) and (I) may have both crosslinking and adhesion promoting properties. One skilled in the art would recognize that the amount of ingredient (I) added to the composition is in addition to the amount of ingredient (G), and that when ingredient (I) is added, the adhesion promoter selected may be the same as or different from the crosslinker. However, the amount of ingredient (I) may range from 0 to 5 weight %, alternatively 0 to 2 weight %, and alternatively 0.5 to 1.5 weight %, based on the weight of the composition. Ingredient (I) may be one adhesion promoter. Alternatively, ingredient (I) may comprise two or more different adhesion promoters.

Organofunctional alkoxysilane crosslinkers and adhesion promoters are known in the art and commercially available. For example, vinyltriethoxysilane, vinyltrimethoxysilane, phenyltrimethoxysilane, tetraethoxysilane, isobutyltrimethoxysilane, (ethylenediaminepropyl)trimethoxysilane, and (methacryloxypropyl)trimethoxysilane are available from Dow Corning Corporation of Midland, Mich., U.S.A. Aminopropyltriethoxysilane and gamma-isocyanopropyltriethoxysilane are available from under the designation SILQUEST® (A-1100 and A-1310, respectively) from Momentive Performance Materials, 187 Danbury Road, Wilton, Conn. USA.

One skilled in the art would recognize when selecting ingredients (G), (H), and (I) that there may be overlap between crosslinker (affecting the physical properties of the cured product), adhesion promoter (affecting the adhesion of the cured product), and chemical drying agent (affecting shelf-stability). One skilled in the art would be able to distinguish among and select ingredients (G), (H), and/or (I) based on various factors including the intended use of the composition and whether the composition will be prepared as a one-part or multiple-part composition.

### Ingredient (J) Microcrystalline Wax

Ingredient (J) is a microcrystalline wax that is a solid at 25° C. (wax). The melting point may be selected such that the wax has a melting point at the low end of the desired application temperature range. For example, when the composition will be used in an IG unit, the wax may have a melting point ranging from 80° C. to 100° C. Without wishing to be bound by theory, it is thought that ingredient (J) acts as a process aid that improves flow properties while allowing rapid green strength development (i.e., a strong increase in viscosity, corresponding to increase in the load carrying capability of a seal prepared from the composition, with a temperature drop) upon cooling the composition a few degrees, for example, after the composition is applied to a substrate. Without wishing to be bound by theory, it is thought that incorporation of wax may also facilitate incorporation of fillers, compounding and de-airing (during production of the composition), and mixing (static or dynamic mixing during application of both parts of a two-part composition). It is thought that the wax, when molten, serves as a process aid, substantially easing the incorporation of filler in the sealant during compounding, the compounding process itself, as well as the de-airing step. The wax, with a melt temperature below 100° C., may facilitate mixing of the two parts of a two part sealant composition before application, even in a simple static mixer. The wax may also facilitate application of the composition as a sealant at temperatures ranging from 80° C. to 110° C., alternatively 90° C. to 100° C. with good rheology.

Waxes suitable for use as ingredient (J) may be non-polar hydrocarbons. The waxes may have branched structures, cyclic structures, or combinations thereof. For example, petroleum microcrystalline waxes are available from Strahl & Pitsch, Inc., of West Babylon, N.Y., U.S.A. and include SP 96 (melting point ranging from 62° C. to 69° C.), SP 18 (melting point ranging from 73° C. to 80° C.), SP 19 (melting point ranging from 76° C. to 83° C.), SP 26 (melting point ranging from 76° C. to 83° C.), SP 60 (melting point ranging from 79° C. to 85° C.), SP 617 (melting point ranging from 88° C. to 93° C.), SP 89 (melting point ranging from 90° C. to 95° C.), and SP 624 (melting point ranging from 90° C. to 95° C.). Other petroleum microcrystalline waxes include waxes marketed under the trademark Multiwax® by Crompton Corporation of Petrolia, Pennsylvania, U.S.A. These waxes include 180-W, which comprises saturated branched and cyclic non-polar hydrocarbons and has melting point ranging from 79° C. to 87° C.; Multiwax® W-445, which comprises saturated branched and cyclic non-polar hydrocarbons, and has melting point ranging from 76° C. to 83° C.; and Multiwax® W-835, which comprises saturated branched and cyclic non-polar hydrocarbons, and has melting point ranging from 73° C. to 80° C.

The amount of ingredient (J) depends on various factors including the specific wax selected and the selections of ingredient (C) and ingredients (D) and (E), if present. However, the amount of ingredient (J) may range from 0 to 20 weight %, alternatively 1 to 15 weight %, and alternatively 1 to 5 weight %, based on the weight of the composition. Ingredient (J) may be one wax. Alternatively, ingredient (J) may comprise two or more different waxes.

### Ingredient (K) Anti-Aging Additive

Ingredient (K) is an anti-aging additive. Ingredient (K) may comprise an antioxidant, a UV absorber, a UV stabilizer, a heat stabilizer, or a combination thereof. Examples of UV absorbers include phenol, 2-(2H-benzotriazol-2-yl)-6-dodecyl-4-methyl-, branched and linear (TINUVIN® 571). Examples of UV stabilizers include bis(1,2,2,6,6-pentamethyl-4-piperidyl) sebacate; methyl 1,2,2,6,6-pentamethyl-4-piperidyl/sebacate; and a combination thereof (TINUVIN° 272). These TINUVIN® additives are commercially available from Ciba Specialty Chemicals of Tarrytown, N.Y., U.S.A. Suitable antioxidants are known in the art and commercially available. Suitable antioxidants include phenolic antioxidants and combinations of phenolic antioxidants with stabilizers. Phenolic antioxidants include fully sterically hindered phenols and partially hindered phenols. Stabilizers include organophosphorous derivatives such as trivalent organophosphorous compound, phosphites, phosphonates, and a combination thereof; thiosynergists such as organosulfur compounds including sulfides, dialkyldithiocarbamate, dithiodipropionates, and a combination thereof; and sterically hindered amines such as tetramethyl-piperidine derivatives. Suitable phenolic antioxidants include vitamin E and IRGANOX® 1010 from Ciba Specialty Chemicals, U.S.A. IRGANOX® 1010 comprises pentaerythritol tetrakis(3-(3,5-di-t-butyl-4-hydroxyphenyl)propionate). Oligomeric (higher molecular weight) stabilizers may be used to minimize potential for chemical fogging of IG units and migration. Example of an oligomeric antioxidant stabilizer (specifically, hindered amine light stabilizer (HALS)) is Ciba Tinuvin 622 is a dimethylester of butanedioic acid copolymerized with 4-hydroxy-2,2,6,6-tetramethyl-1-piperidine ethanol.

The amount of ingredient (K) depends on the specific anti-aging additive selected. However, the amount of ingredient (K) may range from 0 to 5 weight %, alternatively 0.5 to 3 weight %, based on the weight of the composition. Ingredient (K) may be one anti-aging additive. Alternatively, ingredient (K) may comprise two or more different anti-aging additives.

### Ingredient (L) Tackifying Agent

Suitable tackifying agents are known in the art. For example, the tackifying agent may comprise an aliphatic hydrocarbon resin such as a hydrogenated polyolefin having 6 to 20 carbon atoms, a hydrogenated terpene resin, a rosin ester, a hydrogenated rosin glycerol ester, or a combination thereof. Tackifying agents are commercially available. Aliphatic hydrocarbon resins are exemplified by ESCOREZ 1102, 1304, 1310, 1315, and 5600 from Exxon Chemical and Eastotac resins from Eastman, such as Eastotac H-100 having a ring and ball softening point of 100° C., Eastotac H-115E having a ring and ball softening point of 115° C., and Eastotac H-130L having a ring and ball softening point of 130° C. Hydrogenated terpene resins are exemplified by Arkon P 100 from Arakawa Chemicals and Wingtack 95 from Goodyear. Hydrogenated rosin glycerol esters are exemplified by Staybelite Ester 10 and Foral from Hercules. Examples of commercially available polyterpenes include Piccolyte A125 from Hercules. Examples of aliphatic/aromatic or cycloaliphatic/aromatic resins include ECR 149B or ECR 179A from Exxon Chemical.

In addition, up to 20 parts by weight, alternatively up to 10 parts by weight, based on the weight of ingredient (L) of a solid tackifying agent (i.e., a tackifying agent having a ring and ball softening point above 25° C.), which is compatible with ingredients (A) and (F) may be added to the composition. Suitable tackifying agents include any compatible resins or mixtures thereof such as (1) natural or modified rosins such, for example, as gum rosin, wood rosin, tall-oil rosin, distilled rosin, hydrogenated rosin, dimerized rosin, and polymerized rosin; (2) glycerol and pentaerythritol esters of natural or modified rosins, such, for example as the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; (3) copolymers and terpolymers of natural terpenes, e.g., styrene/terpene and alpha methyl styrene/terpene; (4) polyterpene resins having a softening point, as determined by ASTM method E28,58T, ranging from 60° C. to 150° C.; the latter polyterpene resins generally resulting from the polymerization of terpene hydrocarbons, such as the bicyclic monoterpene known as pinene, in the presence of Friedel-Crafts catalysts at moderately low temperatures; also included are the hydrogenated polyterpene resins; (5) phenolic modified terpene resins and hydrogenated derivatives thereof, for example, as the resin product resulting from the condensation, in an acidic medium, of a bicyclic terpene and phenol; (6) aliphatic petroleum hydrocarbon resins having a ring and ball softening point ranging from 60° C. to 135° C.; the latter resins resulting from the polymerization of monomers consisting of primarily of olefins and diolefins; also included are the hydrogenated aliphatic petroleum hydrocarbon resins; (7) alicyclic petroleum hydrocarbon resins and the hydrogenated derivatives thereof; and (8) aliphatic/ aromatic or cycloaliphatic/aromatic copolymers and their hydrogenated derivatives.

The amount of ingredient (L) depends on various factors including the specific tackifying agent selected and the selection of ingredient (I). However, the amount of ingredient (L) may range from 0 to 20 weight %, based on the weight of the composition. Ingredient (L) may be one tackifying agent. Alternatively, ingredient (L) may comprise two or more different tackifying agents.

### Preparation of the Composition

The process may be either a batch compounding process or a continuous compounding process. A continuous compounding process may allow for better control of stripping conditions and may minimize duration of heat exposure of the composition. Preferably, a continuous compounding process is used to produce commercial scale quantities of the composition.

The composition may be formulated as a one-part composition or a multiple-part composition, such as a two-part composition. A one-part composition may be prepared by a process comprising mixing the ingredients under shear. The ingredients may be mixed under vacuum or a dry inert gas, or both. The ingredients may be mixed under ambient or elevated temperature, or a combination thereof.

A one-part composition may be prepared by heating ingredients (A) and (F), and ingredient (J), if present, before adding ingredient (C). After combining these ingredients at elevated temperature, ingredient (B) and additional ingredients such as (D), (E), (G), (H), (I), (K), and (L) if any, may be added.

Alternatively, the composition may be prepared as a multiple-part composition, such as the two-part composition described below. One skilled in the art would recognize how to prepare a multiple-part composition by storing ingredient (B) the condensation catalyst and ingredient (C) silanol functional silicone resin in separate parts. An exemplary two-part composition comprises a wet (i.e., silanol-containing) part and a dry (i.e., not containing the silanol functional silicone resin) part. The wet part may be prepared by mixing under shear ingredients comprising (F) a non-reactive, elastomeric, organic polymer, and (C) a silanol functional silicone resin, and one or more of the following optional ingredients: (J) wax, (L) tackifying agent, (E) filler such as reinforcing filler, extending filler, or both. Alternatively, the wet part may be prepared by pre-blending ingredients (F), (J), (L) and optionally (C); then adding 30 to 50% of the total amount of (A); then adding ingredient (E) and the balance of ingredient (A); and finally adding ingredients (G), (I), and (K). In this embodiment, the dry part may comprise ingredients (B), (D), optionally (E), (F), and (H), and optionally (J).

The dry part may be prepared by mixing under shear ingredients comprising (A) a moisture-curable, silane-functional, elastomeric, organic polymer, (F) a non-reactive, elastomeric, organic polymer, (B) a condensation catalyst; and one or more of the following optional ingredients: (J) wax, (L) tackifying agent, (G) crosslinker (H) chemical drying agent, (K) stabilizer, and (I) adhesion promoter.

Alternatively, the wet part may be prepared by mixing under shear ingredients comprising (A) a moisture-curable, silane-functional, elastomeric, organic polymer, (F) a non-reactive, elastomeric, organic polymer, and (C) a silanol functional silicone resin. When the wet part comprises ingredient (A) care must be taken that none of the other ingredients in the wet part unintentionally may act as a condensation catalyst. In this case, consideration should to be given to the nature of the silanol functional silicone resin (C). The dry part may be prepared by mixing under shear ingredients comprising (A) a moisture-curable, silane-functional, elastomeric, organic polymer and (B) a condensation catalyst, optionally (G) a crosslinker, optionally (H) a chemical drying agent, and optionally (I) an adhesion promoter. Each of the wet part and the dry part may optionally further comprise one or more additional ingredients selected from, (F) a non-reactive, elastomeric, organic polymer, (J) a microcrystalline wax, which is a solid at 25° C., (K) an anti-aging additive, and (L) a tackifying agent.

The process conditions of shear and heating are selected such the ingredients are well mixed during the continuous compounding operation to prepare the composition. To achieve sufficient homogeneous mixing during this operation (especially in terms of the polymers and the powder components, e.g., drying agent and filler, one skilled in the art may choose a compounding temperature close to the application temperature, so that the polymer components are sufficiently liquid to allow efficient incorporation of the powder components. However, because of the mechanical shear required for this operation, the actual compounding temperature often will be substantially above the application temperature. For instance, when manufacturing the composition with a twin-screw extruder, temperature may run 30 to 140° C. above the application temperature (e.g., temperature may range from 130 to 200° C. when the composition will be applied at 80 to 100° C. in an IG unit), and temperature may sometimes be as high as 100 to 110° C. above the application temperature. While the composition is not exposed to this temperature for prolonged periods of time, the silanol functionality of ingredient (C) needs to survive this compounding step. Without wishing to be bound by theory, it is thought that ingredient (C) is a silicone resin in which the silanol is sufficiently tightly bound in order for sufficient amounts of silanol to survive the compounding step, while at the same time, the silanol is sufficiently reactive to initiate cure of the composition at the application temperature.

### Method of Use

Ingredient (A) allows the composition to cure via condensation reaction. Ingredients (A) and (F) are considered low permeability polymers; these polymers minimize moisture permeability and gas permeability of the cured product of the composition. Therefore, ingredient (C) is a source of silanol that reacts over an application temperature range. Ingredient (C) is included to cure the composition. In a two-part composition, addition of ingredient (C) is a suitable means of inducing cure upon mixing of the wet part and the dry part when the composition is heated. Since the composition is exposed to the application temperature in the application equipment only for a limited duration, ingredient (C) may be chosen such that it partially cures the composition during application, e.g., partial cure may be to a degree of 30% to 50%, alternatively 30% to 40%. For instance, when the composition is mixed at room temperature or below 40 to 60° C., the composition may cure too slowly for the industrial manufacturing process of IG units. It is desirable to select ingredient (C) such that the composition cures achieves an initial green strength sufficient to allow an IG unit containing the composition to be moved after fabrication and before further cure of the composition. Ingredient (C) may be selected such that cure is 60% to 90%, alternatively 65% to 80%, of theoretical after 1 week to 1 month under ambient conditions,

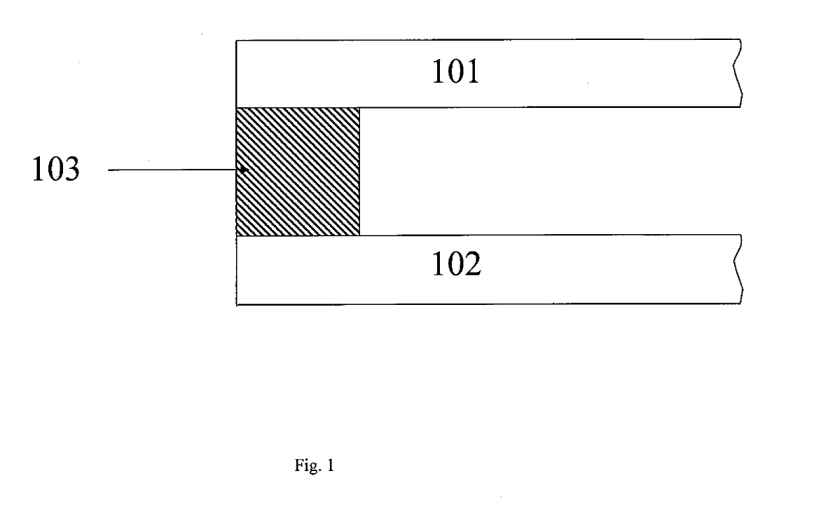

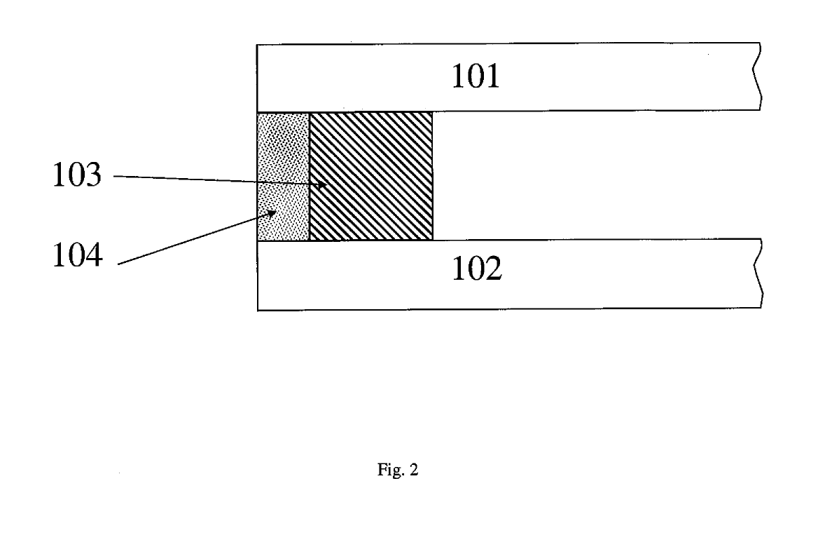

The composition of this invention may be used in IG applications. FIGS. 1 (single-seal) and 2 (dual-seal) are cross sectional views showing portions of IG units. Each IG unit comprises a first glass pane 101, a second glass pane 102 spaced a distance from the first glass pane 101. In FIG. 1, a cured product 103 of the composition described above is interposed in the interpane space between the first glass pane 101 and the second glass pane 102. The cured product 103 may act as an integrated edge-seal, i.e., acting as a water vapour barrier, a gas barrier, a sealant between the panes, a spacer, an adhesive, and a desiccant matrix. FIG. 2 shows the use of the cured product 103 of the composition described above as a primary sealant. A secondary sealant 104, such as a polysulfide, polyurethane, or silicone, is adhered to the primary sealant and the glass panes 101, 102. In the case of dual-seal (FIG. 2) the cured product 103 may act as an integrated edge-seal, i.e., acting as a water vapour barrier, a gas barrier, a sealant between the panes, a spacer, an adhesive, and a desiccant matrix. The secondary sealant 104 then further supports the sealing and bonding (adhesive) function of the cured product 103. Alternatively, the composition described herein may be used as a primary sealant or a secondary sealant in an IG unit that has a conventional spacer.

The process of applying the two-part composition may comprise melting the two parts and feeding them by suitable means (e.g., conventional equipment such as a hot melt pump or extruder) into a heated static or dynamic mixer and from there via a heated hose to an application nozzle. The process for applying the sealant from the nozzle onto the glass to form the edge-seal and for making the IG unit offers the advantages of employing the same or similar equipment currently used for making conventional TPS® IG units, with the exception that the equipment may be modified to handle two parts (dual feeds) when a two part composition is used, and the composition described above also allows manufacture of single seals. One process used to make TPS® units comprises applying the composition as a seal filament around the perimeter of a first glass pane, moving a second glass pane in parallel position in close proximity to the first glass pane, optionally filling the inter-pane volume with a gas (such as argon), and closing the IG unit by pressing the second glass pane against the filament seal formed on the first glass pane (see, for instance, EP 0,805,254 B1, WO 95/11,363, WO 96/09,456). Alternatively, the glass panes may be held in a parallel, spaced position and the composition extruded between the glass panes (see WO 90/02,696), or the composition may be first extruded onto a support to which the composition adheres less well than to glass, then the composition is transferred from the support onto one glass pane, both glass panes are made to coincide and are then pressed together (see WO 95/11,364).

The IG unit may be prepared by a process comprising i) bringing the first glass pane 101 and the second glass pane 102 into a parallel position spaced apart by an interpane space, ii) applying the composition described above into the interpane space along the perimeter of the first glass pane 101 and the second glass pane 102, and iii) curing the composition.

Alternatively, the IG unit may be prepared by a process comprising: i) applying the composition described above as a filament seal around the perimeter of the first glass pane 101, ii) moving the second glass pane 102 into a parallel position to the first glass pane 101 such that the first glass pane 101 and the second glass pane 102 are spaced apart by an interpane space, optionally iii) filling the interpane space with a gas such as argon or dry air, iv) pressing the second glass pane 102 against the filament seal formed on the first glass pane 101, and v) curing the composition.

Alternatively, the IG unit may be prepared by a process comprising: i) applying a composition described above as a filament seal onto a support to which the composition adheres less well than to glass, ii) transferring the filament seal from the support onto the first glass pane 101, iii) pressing the first glass pane 101 and the second glass pane 102 together in a parallel position, and iv) curing the composition.

In any of the processes for preparing the IG unit, a one-part or a two-part composition described above may be used. When a two-part composition is used, the two parts may be mixed shortly before process step i) or process step ii). These processes for preparing the IG unit may offer the advantage that curing the composition may be performed in the absence of atmospheric moisture. For purposes of this application, “absence of atmospheric moisture” means that any amount of moisture present in the ambient atmosphere is insufficient to cure the composition described herein within a time period of 1 week to 1 month, alternatively 3 to 4 weeks. Curing may be performed by heating the composition to the application temperature range, thereby reacting the silanol of ingredient (C). Curing may be performed during or after application of the composition to a glass pane. In the processes for preparing the IG unit, applying the composition may be performed at a temperature ranging from 80° C. to 140° C.

### EXAMPLES

The following examples are included to demonstrate the invention to those of ordinary skill in the art. However, those of skill in the art should, in light of the present disclosure, appreciate that many changes can be made in the specific embodiments which are disclosed and still obtain a like or similar result without departing from the spirit and scope of the invention set forth in the claims. All amounts, ratios, and percentages are by weight unless otherwise indicated. The ingredients described in Table 1 were used in the following examples. All parameter values were taken from the relevant datasheets current at the time of filing the priority application (U.S. 61/162378) for this application. All values of Mn are taken from datasheets for the products concerned or were measured by Triple Detection Size Exclusion Chromatography and calculated on the basis of polystyrene molecular weight standards unless otherwise indicated. All viscosity measurements are taken at 25° C. unless otherwise indicated.

TABLE 1
Ingredient Information

| Ingredient | Chemical Name | Physical Properties, viscosity units are mPa · s | Commercial Source |
|---|---|---|---|
| (A1) | A silylated copolymer comprising a | The silylated copolymer is a random | Dow Corning Corporation, Midland, |
| | reaction product of isobutylene and | polyisobutylene-p-methylstyrene copolymer grafted | Michigan, U.S.A. |
| | paramethylstyrene with methylvinyl | with vinyldimethoxysilane. The molecular weight | |
| | dimethoxysilane. | of the polyisobutylene-p-methylstyrene ranges from | |
| | | 63,000 to 870,000 before grafting. After grafting, | |
| | | the molecular weight ranges from 28,000 to 33,000. | |
| | | Viscosity is 43600 @ 150° C. | |
| (A2) | A silylated copolymer comprising a | The silylated copolymer was a random | Dow Corning Corporation, Midland, |
| | reaction product of isobutylene and | polyisobutylene-isoprene copolymer (Exxon 268) | Michigan, U.S.A. |
| | isoprene with methylvinyl | grafted with vinyldimethoxysilane. (Exxon 268) | |
| | dimethoxysilane. | was weight average molecular weight Mw of | |
| | | 550,000 and number average molecular weight Mn | |
| | | of 220,000 before grafting. After grafting, the | |
| | | molecular weights ranged from Mw of 100,000 to | |
| | | 250,000 and Mn of 10,000 to 15,000. The amount | |
| | | of isoprene was 1.7 mol % | |
| (A3) | A silylated copolymer comprising a | The silylated copolymer was a random | Dow Corning Corporation, Midland, |
| | reaction product of isobutylene and | polyisobutylene-isoprene copolymer (Exxon 365) | Michigan, U.S.A. |
| | isoprene with methylvinyl | grafted with vinyldimethoxysilane. Before | |
| | dimethoxysilane. | grafting, molecular weights of the copolymer were | |
| | | Mw of 410,000 and Mn of 160,000. After grafting, | |
| | | the molecular weights ranged from Mw of 100,000 | |
| | | to 250,000 and Mn of 10,000 to 15,000. The | |
| | | amount of isoprene was 2.2-2.3 mol %. | |
| (B1) | Di-(n-butyl)tin bis-ketonate | | Acima Chemical Industries Metatin |
| | | | 740 |
| (B2) | Di-n-Butyltin-di-Laurate (DBTDL) | | Acima Chemical Industries Metatin ® |
| | | | 712 |
| (B3) | Dimethyl tin dineodecanoate (DMDTN) | | Fomrez UL 28 from Momentive |
| (C1) | Hydroxy-terminated phenyl | This resin is a phenyl T type resin having a silanol | |
| | silsesquioxane resin | content ranging from 5% to 7% based on the | |
| | | weight of the resin and weight average molecular | |
| | | weight (Mw) of 2660 and number average | |
| | | molecular weight (Mn) of 1720. | |
| (C2) | Hydroxy-terminated methyl phenyl | This resin is a DT type resin having 5% silanol | |
| | silicone resin. | groups based on the weight of the resin, Mw of | |
| | | 4300 and Mn 1700. The resin has dimethyl siloxy | |
| | | units 5 mol % dimethyldisiloxy units, 48 mol % | |
| | | phenyltrisiloxyunits, adn 47 mol % methyltrisiloxy | |
| | | units. | |
| (D1) | 3 Å zeolite molecular sieve (dry) | Potassium aluminosilicate | UOP Molsiv 3A |
| (D2) | 4 Å molecular sieve (dry) | Sodium aluminosilicate (note: Alflexil 100 was | Alflexil 100 from A. E. Fischer |
| | | dried at 260° C. for 2 hours to desorb water) | Chemie GmbH & Co. KG of |
| | | | Wiesbaden, Germany |
| (D3) | 3 Å zeolite molecular sieve (dry) | Potassium aluminosilicate | Grace Davidson, Sylosiv 3A |
| (D5) | Hydrated 4 Å molecular sieve | Saturated sodium aluminosilicate | Ineos Doucil 4A from Ineos Silicas |
| (D6) | Hydrated 4 Å molecular sieve | Saturated sodium aluminosilicate | Alflexil 100 from A. E. Fischer |
| | | | Chemie GmbH & Co. KG |
| (E1) | Amorphous carbon black | Average particle size 0.05 μm, specific surface | Elementis Superjet Carbon Black LB- |
| | | area: 44 m²/g, Oil absorption: 120 (g/100 g) | 1011 or WMS 1011 |
| (E2) | Fine particle size, wet ground, | Mean particle diameter: 3 μm, surface area: 2 m²/g, | Imerys Marble Inc. Gama-Sperse ® |
| | ammonium stearate treated marble | treatment level: ~1 wt % | CS-11 |
| (E3) | Untreated fumed silica | Surface area: 108 m²/g | Cabot Corporation, Cab-O-Sil.L-90 |
| (E4) | precipitated CaCO₃ treated with fatty | Mean particle diameter: <0.1 μm, specific surface | Solvay Chemicals Winnofil |
| | acid (i.e., stearic acid) | (BET): 20 m²/g, coating content: 2.7 wt %, | SPMSpecialt Minerals Incorporated, |
| | | | Thixocarb |
| (F1) | Polyisobutylene | Average Mn is 950 | Soltex PB-24 |
| | | Viscosity is 110 @ 120° C. | |
| (F2) | Polyisobutylene | Average Mn is 36,000 | BASF Oppanol B-10 |
| | | Viscosity is 40,000 @ 150° C. | |
| (F3) | Polyisobutylene | Average Mn is 51,000 | BASF Oppanol B-12 |
| | | Viscosity is 150,000 @ 150° C. | |
| (F4) | Polyisobutylene | Average Mn is 75,000 | BASF Oppanol B-15 |
| | | Viscosity is 700,000 @ 150° C. | |
| (F5) | Polyolefin Plastomer | Density of 0.874 g/ml, viscosity of 17,000 cps at | Dow Chemical Company, Affinity GA |
| | | 350° F. (177° C.) (by Brookfield spindle #31), and | 1950 POP |
| | | approximate melt index of 500. | |
| (F6) | Styrene/ethylene/propylene/styrene | Density of 0.88 g/ml, Styrene content of 13 wt %, | Kuraray America, Inc., Septon 2063 |
| | block copolymer (SEPS) | pellets | |
| (G1) | Vinyl triethoxysilane | | Dow Corning Corporation, Midland, |
| | | | Michigan, U.S.A. |
| (G2) | Vinyl trimethoxysilane | Bp 123° C. | Dow Corning Corporation, Midland, |
| | | | Michigan, U.S.A. |
| (G3) | Phenyltrimethoxysilane | | Dow Corning Corporation, Midland, |
| | | | Michigan, U.S.A. |
| (I1) | Tetraethylortho silicate (TEOS) | | Dow Corning Corporation, Midland, |
| | | | Michigan, U.S.A. |
| (I2) | Gamma-Aminopropyltriethoxysilane | | GE Silicones Silquest ® A-1100 |
| | | | Silane |
| (I3) | Methacryloxypropyl trimethoxysilane | | Dow Corning Corporation, Midland, |
| | | | Michigan, U.S.A. Z-6030 |
| (I4) | Ethylenediaminopropyltrimethoxy- | H₂NC₂H₄NHC₃H₆—Si(OCH₃)₃ | Dow Corning Corporation, Midland, |
| | silane | | Michigan, U.S.A. Z-6020 |
| (I5) | (Gamma- | | GE Silicones Silquest ® A-1310 |
| | isocyanopropyl)triethoxysilane | | Silane |
| (J1) | White, highly refined, high molecular | Melting Point, ° C. 79.4-86.7 ASTM D127 | Crompton Witco Multiwax 180-W |
| | weight microcrystalline petroleum | | |
| | wax; consists of saturated branched | | |
| | and cyclic non-polar hydrocarbons. | | |
| (J2) | microcrystalline petroleum wax | Melting Point ASTM D 127 88.3-92.7° C. | Strahl & Pitsch S&P 617 |
| (K1) | Mixture of 80% bis(1,2,2,6,6- | | Ciba ® Tinuvin ® 292 |
| | pentamethyl-4-piperidinyl)sebacate | | |
| | and 20% methyl(1,2,2,6,6- | | |
| | pentamethyl-4-piperidinyl)sebacate | | |
| | (general-purpose liquid hindered- | | |
| | amine light stabilizer (HALS)) | | |
| (K2) | 2-(2H-benzotriazol-2-yl)-6-dodecyl-4- | | Ciba ® Tinuvin 571 |
| | methylphenol, branched and linear | | |
| | (benzotriazole type UV absorber) | | |
| (L1) | Hydrogenated hydrocarbon tackifying | Ring and Ball softening point ranging from 95 to | Eastman Eastotac H100 |
| | resin made up of hydrogenated | 105° C. | |
| | hydrocarbons having 6 to 20 carbon | Average Mn is 450 | |
| | atoms | | |

### Reference Example 1

### Property Evaluation Methods

### Swell Gel

Resistance to a solvent, toluene, commonly used to dissolve the compositions in the uncured state was used to determine completion of cure. A sample was allowed to cure for 5 days after which a known weight was placed into a 1 ounce (28.349 g) vial with toluene. Every few days the toluene was replaced with fresh toluene. After one week the sample was removed decanting off the bulk of solvent and then placing it into a pre-weighed dish for drying. The amount left after drying to a stable level was measured and compared to the weight of original sample to determine the amount of cured network of polymer, fillers and other curable materials.

### Compression Test

Compressibility was evaluated by the following method. First, the sample of the composition was dispensed through a hot-melt cartridge at elevated temperature onto a glass panel. The height of the resulting bead was measured. A second glass panel was applied on the bead, either with or without additional weight as specified below. Bead height was measured again after allowing the sample to cool for 15 minutes. The % compression was calculated as (original bead height−compressed bead height)/original bead height*100.

### Reference Example 2

In order to achieve the level of cure previously indicated within 3-4 weeks after the application of the composition, the composition needs to contain a sufficient amount of silanol that is available at the given application temperature. Availability of silanol at the application temperature is preferably determined on the “wet” part of a two part composition rather than on the water release agent itself or the mixed composition. Measurement of water availability on the water release agent itself neglects any availability of water in the composition due to various other factors, such as solubility of water in the polymeric ingredients of the composition. Measurement of water availability in the mixed composition neglects to account for reaction of water with silanes, silicon-reactive polymer and other water scavenging ingredients, which may result in the conversion of water to reaction by-products, such as alcohols.

### Comparative Examples 1 to 3 and Examples 4 to 7

### Twin Screw Extruder

Samples were prepared on a twin screw extruder by mixing the ingredients in Table 2. Ingredients were added in the following order. First, ingredients (F6), (F5), (J2), and (C1) were pre-blended. Next 50% of ingredient (A3) was added, then ingredient (E3), then ingredient (E4), then a mixture of ingredients (K1) and (K2), and finally the remaining 50% of ingredient (A3). The operating temperature of the extruder was 130° C. The pressure of the system varied throughout the extruder and ranged between vacuum and 500 psig.

The extruder used to prepare the samples was a Coperion Model ZSK-25 co-rotating, fully intermeshing twin screw extruder. The screw diameter was 25 mm and the overall length was 48:1 L/D (length to diameter ratio). The maximum screw speed of this extruder was 1200 rpm with a power of 22.5 kw.

TABLE 2
Ingredients

| Ingredient, | | | | | | | |
|---|---|---|---|---|---|---|---|
| Amounts in wt % | 1 | 2 | 3 | 4 | 5 | 6 | 7 |
| (A3) butyl | 50.2 | 50.2 | 50.2 | 50.2 | 50.2 | 50.2 | 50.2 |
| (F6) Septon | 12.5 | 12.5 | 12.5 | 12.5 | 12.5 | 12.5 | 12.5 |
| (F5) Affinity | 7.5 | 7.5 | 7.5 | 7.5 | 7.5 | 7.5 | 7.5 |
| (J2)Wax | 1 | 1 | 1 | 1 | 1 | 1 | 1 |
| (E3) Silica | 8 | 8 | 8 | 8 | 8 | 8 | 8 |
| (E4) CaCO₃ | 20 | 20 | 20 | 17.5 | 15 | 10 | 5 |
| (C1) Resin | 0 | 0 | 0 | 2.5 | 5 | 10 | 15 |
| (K1) | 0.4 | 0.4 | 0.4 | 0.4 | 0.4 | 0.4 | 0.4 |
| (K2) | 0.4 | 0.4 | 0.4 | 0.4 | 0.4 | 0.4 | 0.4 |

365 g of each base sample in Table 1 were prepared, and 55 g of each were mixed with a curing agent in a Haake batch mixer at 110° C. and 20 rpm. The curing agent contained 0.5 g of ingredient (I4) and (ethylenediaminepropyl)trimethoxysilane and 0.24 g of ingredient (B3) dimethyl tin dineodecanoate (DMDTN).

The degree of cure was evaluated using the swell gel test according to the method in Reference Example 1. An initial cure (taken on the same day as the base was mixed with the curing agent) and a second reading 28 days later was recorded. The results are in Table 3.

| Example | Initial Cure Present? | 28 Day Cure (%) |
|---|---|---|
| 1 (comparative) | No | 0 |
| 2 (comparative) | No | 0 |
| 3 (comparative) | No | 0 |
| 4 | Some | Not tested |
| 5 | Yes | 64 |
| 6 | Yes | 66 |
| 7 | Yes | 62 |

These examples and comparative examples show that a composition described herein can be prepared in commercial continuous process. The silanol functional resin can retain enough silanol functionality to cure the composition after the composition is prepared in the continuous compounding equipment.

### Examples 8 to 11

### Comparing Resins

Samples were prepared by mixing the ingredients in Table 4 in a Haake mixer at 110° C. and 20 rpm. The degree of cure was evaluated using the swell gel test according to the method in Reference Example 1. An initial cure (taken within 24 hours of mixing) and a second reading 28 days later was recorded. The results are in Table 4.

TABLE 4

| Ingredient | | | | |
|---|---|---|---|---|
| (Amount in grams) | 8 (comparative) | 9 | 10 | 11 |
| (A3) | 55 | 55 | 55 | 55 |
| (C1) | 3.0 | 0 | 5.5 | 0 |
| (C2) | 0 | 4.2 | 0 | 7.7 |
| (B3) | 0.4 | 0.4 | 0.4 | 0.4 |
| Initial Cure (%) | 32 | 49 | 54 | 76 |
| 28 Day Cure (%) | 67 | 79 | 67 | 80 |

These examples show that different silanol functional silicone resins may be used to cure the composition described herein.

### Examples 12 to 13

### Improved Shear Sensitivity and Slump Properties

Two samples were prepared as in examples 8 to 11, except the ingredients in Table 5 were used. Compression of the samples was tested according to the method in Reference Example 1. The results are in Table 5.

TABLE 5

| Ingredient | | |
|---|---|---|
| (amount in weight %) | 12 (comparative) | 13 |
| (A3) | 52.8 | 55 |
| (F6) | 12.5 | 7.1 |
| (F5) | 7.5 | 7.1 |
| (J2) | 1 | 0.7 |
| (E3) | 7.5 | 10.3 |
| (E4) | 17.5 | 11.6 |
| (C1) | 0 | 7.0 |
| (G3) | 0.4 | 0.4 |
| (K1) | 0.4 | 0.4 |
| (K2) | 0.4 | 0.4 |
| % Compression, no weight | 4.6 | 1.7 |
| % Compression, 2.56 kg weight | 13.6 | 29.7 |

Example 13 had less compression than comparative example 12 at the lower weight; but example 13 had more compression than comparative example 12 with the higher weight. Therefore, example 13 and comparative example 12 show that the composition described above may have improved slump and shear sensitivity as compared to a similar composition that does not contain the silanol functional silicone resin.

1. A composition comprising:
(A) 10 to 65 weight % of a moisture-curable, silane-functional, organic polymer;
(B) 0.05 to 3 weight % of a condensation catalyst;
(C) 1 to 25 weight % of a silanol functional silicone resin;
(D) 0 to 25 weight % of a physical drying agent;
(E) 0 to 30 weight % of a filler other than ingredient (D);
(F) 0 to 50 weight % of a non-reactive, elastomeric, organic polymer;
(G) 0 to 5 weight % of a crosslinker;
(H) 0 to 5 weight % of a chemical drying agent other than ingredient (G);
(I) 0 to 5 weight % of an adhesion promoter other than ingredients (G) and (H);
(J) 0 to 20 weight % of a microcrystalline wax, which is a solid at 25° C.;
(K) 0 to 5 weight % of an anti-aging additive; and
(L) 0 to 20 weight % of a tackifying agent;
with the total weight % of the composition being 100%.

2. The composition of claim 1 where the composition is prepared as a multiple part composition comprising (I) a wet part and (II) a dry part, and where
(I) the wet part comprises:
(C) the silanol functional silicone resin,
optionally (F) the non-reactive, elastomeric, organic polymer,
optionally (J) wax,
optionally (L) tackifying agent,
optionally (E) filler, and
optionally (K) the anti-aging additive, and
(II) the dry part comprises
the moisture-curable, silane-functional, elastomeric, organic polymer,
the condensation catalyst,
optionally (F) the non-reactive, elastomeric, polymer,
optionally (D) the physical drying agent,
optionally (J) the wax,
optionally (L) the tackifying agent,
optionally (G) the crosslinker,
optionally (H) the chemical drying agent,
optionally (K) the anti-aging additive, and
optionally (I) the adhesion promoter.

3. The composition of claim 1 where the composition is prepared as a multiple part composition comprising (I) a wet part and (II) a dry part, and where
(I) the wet part comprises
the moisture-curable, silane-functional, elastomeric, organic polymer,
the silanol functional silicone resin,
optionally (E) the filler,
optionally (F) the non-reactive, elastomeric, organic polymer,
optionally (J) the wax,
optionally (L) the tackifying agent, and
optionally (K) the anti-aging additive, and
(II) the dry part comprises
(B) the condensation catalyst,
(D) the physical drying agent,
optionally (F) the non-reactive, elastomeric, organic polymer,
optionally (J) the wax,
optionally (L) the tackifying agent,
optionally (G) the crosslinker,
optionally (H) the chemical drying agent,
optionally (K) the anti-aging additive, and
optionally (I) the adhesion promoter.

4. A composition according to any preceding claim 1 wherein (A) the moisture-curable, silane-functional, organic polymer has a low permeability.

5. A process for making the composition of claim 1 comprising mixing the ingredients under shear, and where the ingredients are mixed under vacuum or dry inert gas, or both.

6. (canceled)

7. A process for making the composition of claim 2 comprising:
1. mixing under shear ingredients comprising (A), (B), and optionally (D) to form the dry part, and
2. mixing under shear ingredients comprising (F) and (C) to form the wet part.

8. A process for making the composition of claim 2 comprising:
1. mixing under shear ingredients comprising (A), (F), and (B) to form the dry part, and
2. mixing under shear ingredients comprising (F) and (C) to form the wet part.

9. A process for making the composition of claim 2 comprising:
1. mixing under shear ingredients comprising (A) and (B) to form the dry part, and
2. mixing under shear ingredients comprising (J) and (C) to form the wet part.

10. A process for making the composition of claim 3 comprising:
1. mixing under shear ingredients comprising (B), and (D) to form the dry part, and
2. mixing under shear ingredients comprising (A) and (C) to form the wet part.

11. The process of claim 7, further comprising:
3. mixing the wet part and the dry part, and
4. applying the product of step 3) to a substrate.

12. (canceled)

13. (canceled)

14. An insulating glass unit (201) comprising:
a first glass pane (101);
a second glass pane (102) spaced a distance from the first glass pane (101); and
a cured product (103) of the composition of claim 1 interposed between the first and second glass panes, where the cured product (103) forms a spacer, seal, moisture barrier, gas barrier, and desiccant matrix between the first and second glass panes.

15. A process for manufacturing the insulating glass unit of claim 14 comprising:
i. bringing the first glass pane and the second glass pane into a parallel position spaced apart by an interpane space,
ii. applying the composition into the interpane space along the perimeter of the first glass pane and the second glass pane, and
iii. curing the composition.

16. A process for manufacturing the insulating glass unit of claim 14 comprising:
i. applying the composition as a filament seal around the perimeter of the first glass pane,
ii. moving the second glass pane into a parallel position to the first glass pane such that the first glass pane and the second glass pane are spaced apart by an interpane space,
optionally
iii. filling the interpane space with a gas,
iv. pressing the second glass pane against the filament seal formed on the first glass pane, and
v. curing the composition.

17. A process for manufacturing the insulating glass unit of claim 14 comprising:
i. applying the composition as a filament seal onto a support to which the composition adheres less well than to glass,
ii. transferring the filament seal from the support onto the first glass pane,
iii. pressing the first glass pane and the second glass pane together in a parallel position, and
iv. curing the composition.

18. (canceled)

19. The process of claim 15, where curing the composition is performed in the absence of atmospheric moisture.

20. A process for curing the composition of claim 1, where curing the composition is performed by heating the composition at a temperature ranging from 80° C. to 110° C. during applying the composition to a substrate, after applying the composition to a substrate, or a combination thereof.

21. A process for curing the composition of claim 1, where curing the composition is performed by heating the composition at a temperature ranging from 80° C. to 110° C. during applying the composition to a substrate, and thereafter cooling the composition to a temperature of 20 to 80 C for 3 to 4 weeks.

22. The composition of claim 1, where ingredient (A) is selected from the group consisting of a silylated copolymer of an iso-mono-olefin and a vinyl aromatic monomer, a silylated homopolymer of the iso-mono-olefin, a silylated homopolymer of the vinyl aromatic monomer, and a combination thereof.

23. The composition of claim 1, where ingredient (A) is selected from the group consisting of a silylated copolymer of isobutylene and an alkylstyrene, a silylated homopolymer of the isobutylene, a silylated copolymer of isoprene and isobutylene, a silylated homopolymer of the alkylstyrene, and a combination thereof.

24. The composition of claim 1, where ingredient (B) is a tin (IV) compound.

25. The composition of claim 1, where ingredient (D) is present, and ingredient (D) is selected from the group consisting of zeolites, molecular sieves, and a combination thereof.

26. The composition of claim 1, where ingredient (E) is present and comprises precipitated calcium carbonate.

27. The composition of claim 1, where ingredient (E) is present, and ingredient (E) is selected from the group consisting of a reinforcing filler, an extending filler, a thixotropic filler, a pigment, and a combination thereof.

28. The composition of claim 1, where ingredient (F) is present, and ingredient (F) is polyisobutylene.

29. The composition of claim 1, where ingredient (G) is present, and ingredient (G) comprises an alkoxysilane, an oligomeric reaction product of the alkoxysilane, or a combination thereof.

30. The composition of claim 1, where ingredient (I) is present, and ingredient (I) is selected from the group consisting of tetraethylortho silicate, gamma-aminopropyltriethoxysilane, methacryloxypropyl trimethoxysilane, (ethylenediaminepropyl)trimethoxysilane, and (gamma-isocyanopropyl)triethoxysilane, and a combination thereof.

31. The composition of claim 1, where ingredient (J) is present, and ingredient (J) is a non-polar hydrocarbon.

32. The composition of claim 1, 2, 3 or 4 where ingredient (K) is present, and ingredient (K) is selected from the group consisting of an antioxidant, a UV absorber, a UV stabilizer, a heat stabilizer, and a combination thereof.

33. The composition of claim 1, where ingredient (L) is present, and ingredient (L) is selected from the group consisting of aliphatic hydrocarbon resin, a hydrogenated terpene resin, a rosin ester, a hydrogenated rosin glycerol ester, and a combination thereof.

34. A method comprising:
I) adding (C) 1 to 25 weight % of a silanol functional silicone resin that has silanol groups reactive over an application temperature range to a composition comprising:
10 to 65 weight % of a moisture-curable, silane-functional, elastomeric, organic polymer;
0.05 to 3 weight % of a condensation catalyst;
0 to 25 weight % of a physical drying agent;
0 to 30 weight % of a filler;
0 to 30 weight % of a non-reactive, elastomeric, organic polymer;
0 to 5 weight % of a crosslinker;
0 to 5 weight % of a chemical drying agent other than ingredient (G);
0 to 5 weight % of an adhesion promoter other than ingredients (G) and (H);
0 to 20 weight % of a microcrystalline wax, which is a solid at 25° C.;
0 to 3 weight % of an anti-aging additive; and
0 to 20 weight % of a tackifying agent,
with the total weight % of the composition being 100%; and
II) reacting the silanol, thereby curing the product of step I).

35. The method of claim 34 comprising mixing the ingredients under shear, and where the ingredients are mixed under vacuum or a dry inert gas, or both.

36. (canceled)

37. The method of claim 34, where step II) is performed in the absence of atmospheric moisture.

38. The method of claim 34, where step II) is performed by heating the composition at a temperature ranging from 80° C. to 120° C. during applying the composition to a substrate, after applying the composition to a substrate, or a combination thereof.

39. The method of claim 34, where step II) is performed by heating the composition at a temperature ranging from 80° C. to 110° C. after the composition is interposed between two substrates.

40-56. (canceled)
